(19) United States
(12) Patent Application Publication
(10) Pub. No.: US 2013/0050402 A1
(43) Pub. Date: Feb. 28, 2013

(54) IMAGE CAPTURING DEVICE AND METHOD FOR IMAGE LOCALIZATION OF OBJECTS

(71) Applicants: GUANG-JIAN WANG, Shenzhen City (CN); XIAO-JUN FU, Shenzhen City (CN); MENG-ZHOU LIU, Shenzhen City (CN); WEN-WU WU, Shenzhen City (CN)

(72) Inventors: GUANG-JIAN WANG, Shenzhen City (CN); XIAO-JUN FU, Shenzhen City (CN); MENG-ZHOU LIU, Shenzhen City (CN); WEN-WU WU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/484,284

(22) Filed: May 31, 2012

(30) Foreign Application Priority Data
Aug. 30, 2011 (CN) 201110252601.8

(51) Int. Cl. H04N 7/00

(52) U.S. Cl. 348/36; 348/E05.024

(57) ABSTRACT

In a method for image localization of an object using an image capturing device, a panoramic image of the object is captured using the image capturing device. The panoramic image includes an image of the object and an image background of the object. One or more boundary points of the object image are obtained according to a pixel value of each pixel point of the object image. Actual coordinate values of each boundary point are calculated, and original coordinate values of each boundary point are obtained based on a standard image retrieved from a storage device. Localization coordinate values of each pixel of the object image are calculated according to the actual coordinate values and the original coordinate values of each boundary point, and a sub-pixel localization image of the object is generated by mapping to the localization coordinate values of each of the pixel points.

### BACKGROUND

1. Technical Field

Embodiments of the present disclosure relate to image processing systems and methods, and particularly to an image capturing device, a storage medium, and a method for image localization of objects.

2. Description of Related Art

In order to analyze performance of products (e.g., motherboards), one or more images of the products may be captured using a camera device. However, the camera device may be installed on a place where the images captured by the camera device are all taken obliquely, for instance, on a floor, or on a ceiling in a suspended state, and not face on or geometrically square. In such a case, distortion may occur on the captured image of the product. To avoid such distortion on the captured image, various kinds of countermeasures have been proposed, such as an optical compensation method or an optical localization method. However, in such a case, the production cost of the camera device becomes very high, and it is still difficult to obtain an image having a high quality.

### BRIEF DESCRIPTION OF THE DRAWINGS

FIG. 1 is a block diagram of one embodiment of an image capturing device including an image localization system.

FIG. 2 is a flowchart of one embodiment of a method for image localization of an object using the image capturing device of FIG. 1.

FIG. 3 is a schematic diagram illustrating one example of a panoramic image of the object captured by the image capturing device.

FIG. 4 is a schematic diagram illustrating one example of an image localization of the object based on the panoramic image.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In the present disclosure, the word “module,” as used herein, refers to logic embodied in hardware or firmware, or to a collection of software instructions, written in a program language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of a non-transitory computer-readable medium include CDs, DVDs, flash memory, and hard disk drives.

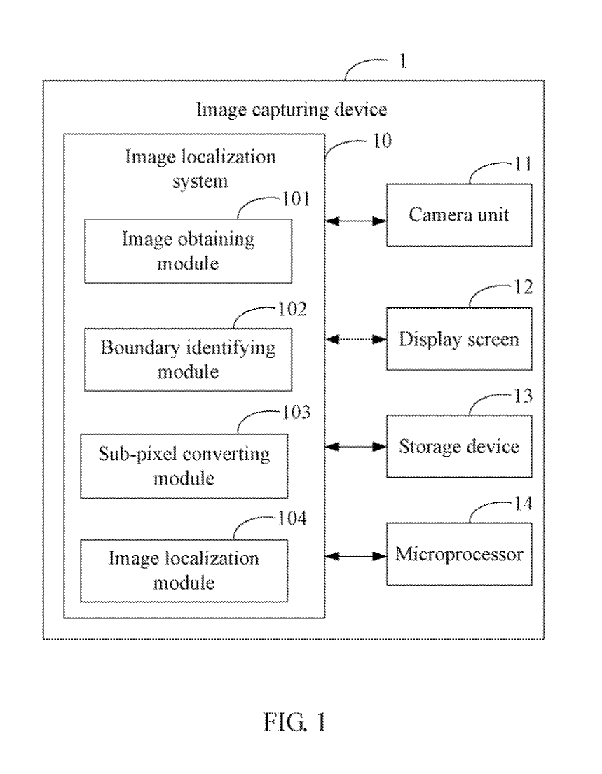

FIG. 1 is a block diagram of one embodiment of an image capturing device 1 including an image localization system 10. In the embodiment, the image capturing device 1 further includes a camera unit 11, a display screen 12, a storage device 13, and a microprocessor 14. The image localization system 10 may include a plurality of functional modules that are stored in the storage device 13 and executed by the at least one microprocessor 14. FIG. 1 is one example of the image capturing device 1, other examples may include more or fewer components than those shown in the embodiment, or have a different configuration of the various components.

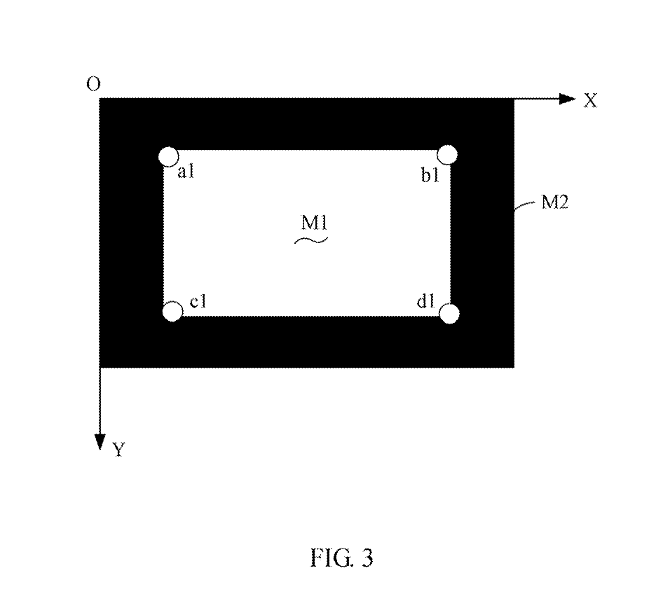

The camera unit 11 may be a digital camera device that is used to capture a panoramic image of the object that includes an image of the object (hereinafter “the object image”) and a background image of the object (hereinafter “the background image). In one example with respect to FIG. 3, if the object is a motherboard on a production line, the object image is an image M1 of the motherboard, and the background image is an image M2 of the production line. The display screen 12 displays the panoramic image of the object.

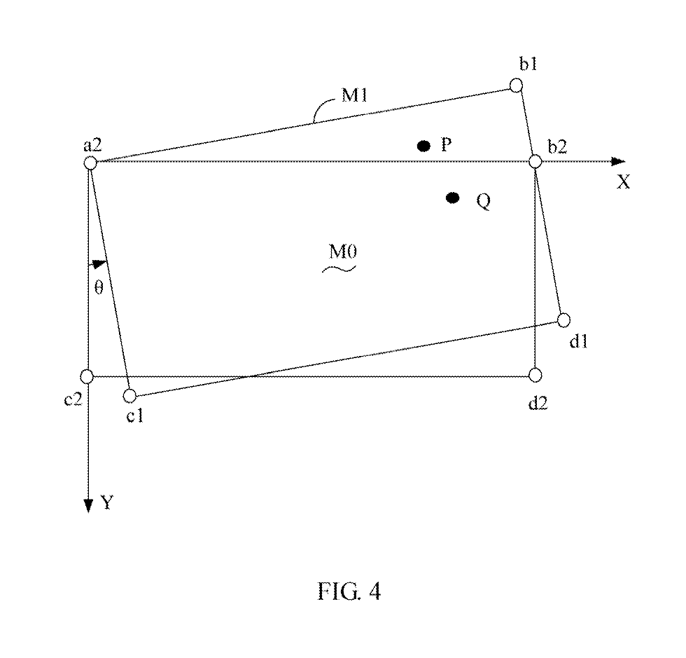

The storage device 13 stores a standard image of the object that is predefined as a reference image of the object including a plurality of boundary points of the object, such as points a2, b2, c2 and d2 as shown in FIG. 4. In one embodiment, the storage device 13 may be an internal storage device, such as a random access memory (RAM) for temporary storage of information, and/or a read only memory (ROM) for permanent storage of information. In some embodiments, the storage device 13 may also be an external storage device, such as an external hard disk, a storage card, or a data storage medium.

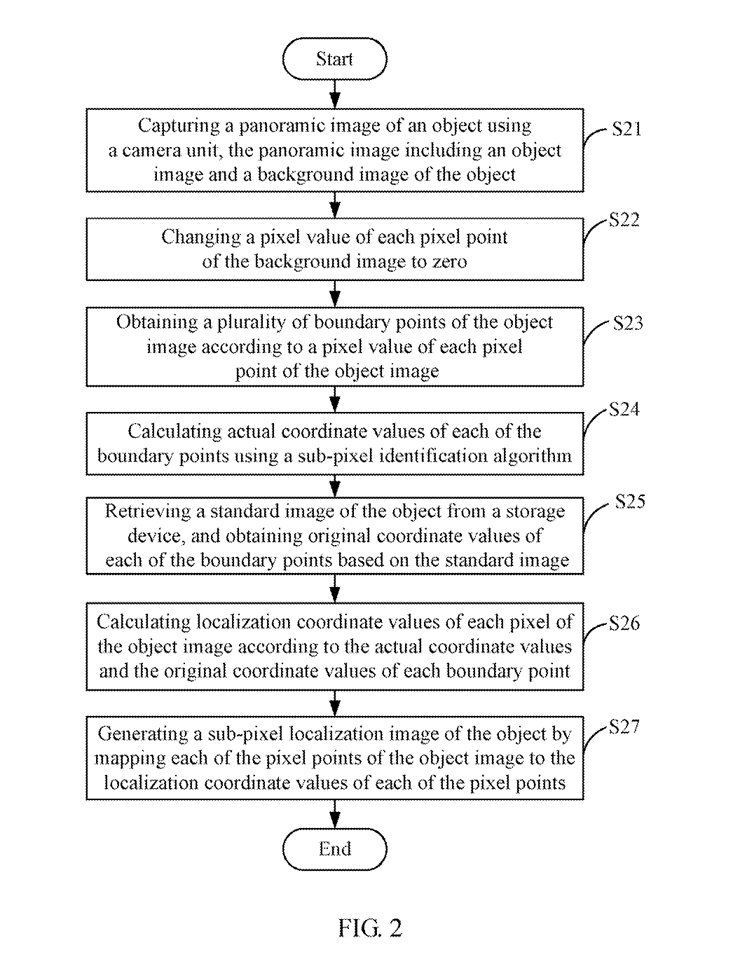

In one embodiment, the image localization system 10 includes an image obtaining module 101, a boundary identifying module 102, a sub-pixel converting module 103, and an image localization module 104. The modules 101-104 may comprise computerized instructions in the form of one or more programs that are stored in the storage device 13 and executed by the at least one microprocessor 14. A detailed descriptions of each module will be given in FIG. 2 as described in the following paragraphs.

FIG. 2 is a flowchart of one embodiment of a method for image localization of an object using the image capturing device 1 of FIG. 1. Depending on the embodiment, additional steps may be added, others removed, and the ordering of the steps may be changed.

In step S21, the image obtaining module 101 obtains a panoramic image of the object captured by the camera unit 11. As mentioned above, the panoramic image includes the object image and the background image. Referring to FIG. 3, assuming that the object is a motherboard on a production line, the object image is the image M1 of the motherboard, and the background image is the image M2 of the production line.

In step S22, the image obtaining module 101 changes all the colors of the background image to black by changing a pixel value of each pixel point of the background image to zero. Referring to FIG. 3, the background image M2 is entirely black, and the pixel value of each pixel point of the background image M2 is zero.

In step S23, the boundary identifying module 102 obtains a plurality of boundary points of the object image according to a pixel value of each pixel point of the object image. In the embodiment, the boundary identifying module 102 creates an X-Y coordinate system based on the panoramic image of the object, and identifies the boundary points, based on the X-Y coordinate system, according to the pixel value of each of the pixel points. Referring to FIG. 3, four boundary points a1, b1, c1 and d1 are identified from the object image based on the X-Y coordinate system. Number of the boundary points may depend on the shape of the object image.

In step S24, the sub-pixel converting module 103 calculates actual coordinate values of each of the boundary points using a sub-pixel identification algorithm. In one embodiment, each pixel of the object image consists of three sub-pixels, being red, green, and blue (RGB). The sub-pixel identification algorithm is a pixel processing method that divides pixels of the boundary points into a certain amount of the sub-pixels, and calculates the actual coordinate values of each of the boundary points according to the sub-pixels. In one example, with respect to FIG. 3, the actual coordinate values of the boundary point a1 are denoted as (135, 187), the actual coordinate values of the boundary point b1 are denoted as (720, 189), the actual coordinate values of the boundary point c1 are denoted as (138, 876), and the actual coordinate values of the boundary point d1 are denoted as (722, 880).

In step S25, the sub-pixel converting module 103 retrieves a standard image of the object from the storage device 13, and obtains original coordinate values of each of the boundary points based on the standard image. In the embodiment, the standard image of the object is predefined as a reference image of the object that includes a plurality of boundary points of the object, such as the points a2, b2, c2 and d2 as shown in FIG. 4. For example, the original coordinate values of the boundary point a2 are denoted as (0, 0), the original coordinate values of the boundary point b2 are denoted as (588, 0), the original coordinate values of the boundary point c2 are denoted as (0, 690), and the original coordinate values of the boundary point d2 are denoted as (588, 690).

In step S26, the image localization module 104 calculates localization coordinate values of each pixel of the object image according to the actual coordinate values and the original coordinate values of each of the boundary points. Referring to FIG. 4, assuming that a pixel point P of the object image M1 has coordinate values (Xp, Yp), the actual coordinate values of each of the boundary points are denoted as a1(0,0), b1(0,X), c1(Y,0) and d1(Y,X), and the original coordinate values of each of the boundary points are denoted as a2(0,0), b2(0,T), c2(R,0) and d2(R,T). The image localization module 104 calculates localization coordinate values Q (Xq, Yq) of the pixel point P according to the formulas: Xq=Xp*T/X, Yq=Yp*R/Y.

In step S27, the image localization module 104 generates a sub-pixel localization image of the object by mapping each of the pixel points of the object image M1 to the localization coordinate values of each of the pixel points, and displays the sub-pixel localization image of the object on the display screen 12.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An image capturing device, comprising:
a camera unit;
a storage device;
at least one processor; and
one or more programs stored in the storage device and executable by the at least one microprocessor, the one or more programs comprising:
an image obtaining module that captures a panoramic image of an object using the camera unit, the panoramic image comprising an object image and a background image of the object;
a boundary identifying module that obtains a plurality of boundary points of the object image according to a pixel value of each pixel point of the object image;
a sub-pixel converting module that calculates actual coordinate values of each of the boundary points using a sub-pixel identification algorithm, retrieves a standard image of the object from the storage device, and obtains original coordinate values of each of the boundary points based on the standard image; and
an image localization module that calculates localization coordinate values of each pixel of the object image according to the actual coordinate values and the original coordinate values of each of the boundary points, and generates a sub-pixel localization image of the object by mapping each of the pixel points of the object image to the localization coordinate values of each of the pixel points.

2. The image capturing device according to claim 1, wherein the image obtaining module further changes all colors of the background image to black by changing a pixel value of each pixel point of the background image to zero.

3. The image capturing device according to claim 1, wherein the boundary identifying module further creates an X-Y coordinate system based on the panoramic image of the object, and identifies the boundary points based on the X-Y coordinate system according to the pixel value of each of the pixel points.

4. The image capturing device according to claim 1, wherein the sub-pixel identification algorithm is a pixel processing method that divides pixels of the boundary points into a certain amount of sub-pixels of the object image and calculates the actual coordinate values of each of the boundary points according to the sub-pixels.

5. The image capturing device according to claim 1, wherein the image localization module further displays the sub-pixel localization image of the object on a display screen of the image capturing device.

6. A method for image localization of an object using an image capturing device, the method comprising:
capturing a panoramic image of an object using a camera unit of the image capturing device, the panoramic image comprising an object image and a background image of the object;
obtaining a plurality of boundary points of the object image according to a pixel value of each pixel point of the object image;
calculating actual coordinate values of each of the boundary points using a sub-pixel identification algorithm;
retrieving a standard image of the object from a storage device of the image capturing device, and obtaining original coordinate values of each of the boundary points based on the standard image;
calculating localization coordinate values of each pixel of the object image according to the actual coordinate value and the original coordinate values of each of the boundary points; and
generating a sub-pixel localization image of the object by mapping each of the pixel points of the object image to the localization coordinate values of each of the pixel points.

7. The method according to claim 6, further comprising:
changing all colors of the background image to black by changing a pixel value of each pixel point of the background image to zero.

8. The method according to claim 6, wherein the boundary points of the object are obtained from the object image by steps of:
creating an X-Y coordinate system based on the panoramic image of the object; and
identifying the boundary points based on the X-Y coordinate system according to the pixel value of each of the pixel points.

9. The method according to claim 6, wherein the sub-pixel identification algorithm is a pixel processing method that divides pixels of the boundary points into a certain amount of sub-pixels of the object image and calculates the actual coordinate values of each of the boundary points according to the sub-pixels.

10. The method according to claim 6, further comprising:
displaying the sub-pixel localization image of the object on a display screen of the image capturing device.

11. A non-transitory computer-readable medium having stored thereon instructions that, when executed by at least one microprocessor of a image capturing device, causes the image capturing device to perform a method for image localization of an object, the method comprising:
capturing a panoramic image of the object using a camera unit of the image capturing device, the panoramic image comprising an object image and a background image of the object;
obtaining a plurality of boundary points of the object image according to a pixel value of each pixel point of the object image;
calculating actual coordinate values of each of the boundary points using a sub-pixel identification algorithm;
retrieving a standard image of the object from a storage device of the image capturing device, and obtaining original coordinate values of each of the boundary points based on the standard image;
calculating localization coordinate values of each pixel of the object image according to the actual coordinate values and the original coordinate values of each of the boundary points; and
generating a sub-pixel localization image of the object by mapping each of the pixel points of the object image to the localization coordinate values of each of the pixel points.

12. The medium according to claim 11, wherein the method further comprises:
changing all colors of the background image to black by changing a pixel value of each pixel point of the background image to zero.

13. The medium according to claim 11, wherein the boundary points of the object are obtained from the object image by steps of:
creating an X-Y coordinate system based on the panoramic image of the object; and
identifying the boundary points based on the X-Y coordinate system according to the pixel value of each of the pixel points.

14. The medium according to claim 11, wherein the sub-pixel identification algorithm is called a pixel processing method that divides pixels of the boundary points into a certain amount of sub-pixels of the object image and calculates the actual coordinate values of each of the boundary points according to the sub-pixels.

15. The medium according to claim 11, wherein the method further comprises:
displaying the sub-pixel localization image of the object on a display screen of the image capturing device.
